(19) United States
(12) Patent Application Publication
(10) Pub. No.: US 2006/0195393 A1
(43) Pub. Date: Aug. 31, 2006

(54) Creation of recurring transactions

(76) Inventors: Kristi M. Weekley, Lake Park, MN (US); John A. Healy, West Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(21) Appl. No.: 11/068,314

(22) Filed: Feb. 28, 2005

(51) Int. Cl. G06Q 40/00

(52) U.S. Cl. 705/39

(57) ABSTRACT

A computer implemented method for recording financial information is provided. The method includes identifying a transaction as recurring. A recurring transaction occurs multiple times according to a frequency value. The method also includes creating two or more transactions from the recurring transaction according to the frequency value.

### BACKGROUND OF THE INVENTION

The present invention relates to software systems for financial management of businesses. In particular, the present invention relates to creating transactions in financial accounts.

Businesses have typically used a variety of mechanisms to control and analyze business operations such as a General Ledger, payroll, human resources, sales orders, employee tracking, customer relations tracking, etc. Tools which provide these functions are often implemented using computer software. A software package may provide a user interface in order for the user to easily enter and view data corresponding to the various business operations. The software packages are also configured to access and update the data, which is stored in a database.

Accounting applications or software can generate financial documents such as a sales invoice, credit memo, vendor invoice and other documents, which translate into transactions for a particular customer, vendor or financial account. For accounting purposes, the transactions generated from the documents must be populated or posted to related financial accounts or an account ledger. For example, transactions or items in a sales invoice are generally posted in an income account and an account receivables account.

Typically, businesses encounter a number of transactions that occur multiple times over a set period of time, with the amount often being the same, but occasionally changing. For example, rent is a typical transaction that occurs every month, with the amount being the same month-to-month, but may increase at the beginning of the next year. In these cases, future recurring transactions are known, but are not created for an account until the expenses are incurred. This situation makes it difficult and cumbersome to assemble and generate future provisional financial reports.

### SUMMARY OF THE INVENTION

A computer implemented method for recording financial information is provided. The method includes identifying a transaction as recurring. Each recurring transaction occurs multiple times according to a frequency value. The method also includes creating two or more transactions from the recurring transaction according to the frequency value. In one embodiment, the recurring transaction as well as two future transactions are created.

### BRIEF DESCRIPTION OF THE DRAWINGS

FIG. 1 is a block diagram of a general computing environment in which the present invention can be useful.

FIG. 2 is a diagram of a selection of transactions with associated adjustments to a General Ledger account.

FIG. 3 is a flow diagram of a method for creating recurring transactions.

FIG. 4 is an exemplary user interface for creating a recurring transaction.

FIG. 5 is an exemplary user interface for specifying a number of transactions to create.

### DETAILED DESCRIPTION OF THE PREFERRED EMBODIMENTS

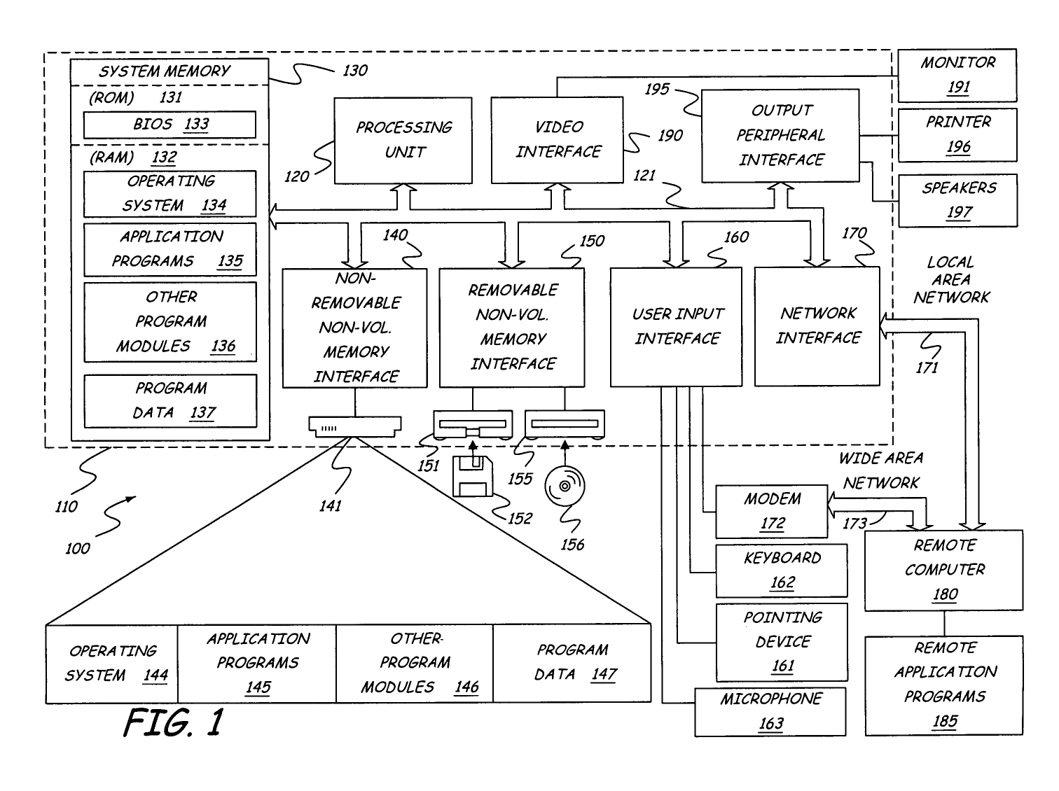

The present invention relates to managing financial information in a computing environment. Prior to discussing the invention in further detail, an exemplary computing environment will be described. FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

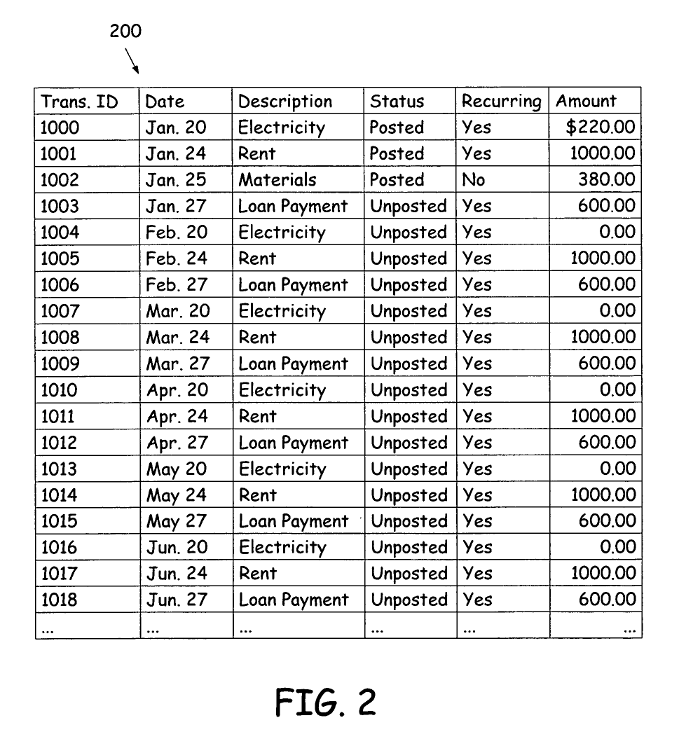

A financial management system can be utilized in the computing environment above. The system can include various modules for interacting with a user and accessing financial information in a database. General Ledger accounts maintain balances that are adjusted as the result of transactions being posted. Each transaction will result in the adjustment of two or more General Ledger accounts. FIG. 2 is a diagram 200 of a selection of transactions in one General Ledger account. The transactions in diagram 200 will also be associated with other General Ledger accounts. The selection for the one General Ledger account occurs on January 26th, wherein it is shown that transactions 1000, 1001 and 1002 have a status that is “posted”. A posted transaction adjusts the balance in the account. The account also includes transactions 1003 through 1018, which all have a status as “unposted”. The overall balance of the account is not affected by an unposted transaction. Transactions 1000-1001 and 1003-1018 are denoted as “recurring” transactions. A recurring transaction is a transaction that occurs multiple times at a specified frequency. A recurring transaction that has been created and unposted will appear on provisional financial reports. Thus, if a business wishes to generate a report for the next six months, all recurring transactions that are created but unposted will figure in a provisional report, but not a current financial report.

For example, a provisional report for the next six months would show recurring transactions that have been created on January 27, February 27, March 27, April 27, May 27 and June 27 for recurring loan payment transactions. Likewise, recurring rent transactions would show on February 24, March 24, April 24, May 24 and June 24. The rent transactions show an amount of $1000 while the loan payment transactions show an amount of $600. There are also transactions created for recurring electricity transactions. Since the amount of future electricity transaction is variable, it is shown with an amount of $0. This amount is updated prior to posting the transaction.

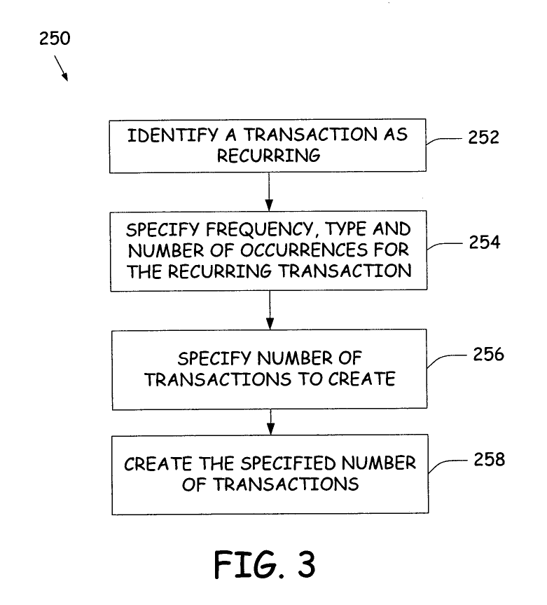

FIG. 3 is a flow diagram of a method 250 for creating recurring transactions. At step 252, a transaction is identified as recurring. For example, a user may identify a transaction as recurring through a user interface module. The recurring transaction occurs multiple times. Next, at step 254, a frequency, a type, and a number of occurrences for the recurring transaction is specified. For example, a rent recurring transaction may include a monthly frequency, a fixed type and 24 occurrences, which accounts for two years of rent payments at a fixed amount. A user interface can be presented to a user in order to specify these parameters. At step 256, a number of transactions to create are specified. For example, the user can choose to create the recurring transactions for only the next 12 months. Thus, if a provisional report is generated for a General Ledger account or accounts, the specified transactions will be included in the provisional report. However, the transactions will not alter the current balance in the associated accounts. The specified transactions are then created at step 258. A posting procedure can be used to post unposted transactions to the associated accounts. The posting procedure can be performed manually or by a scheduled process.

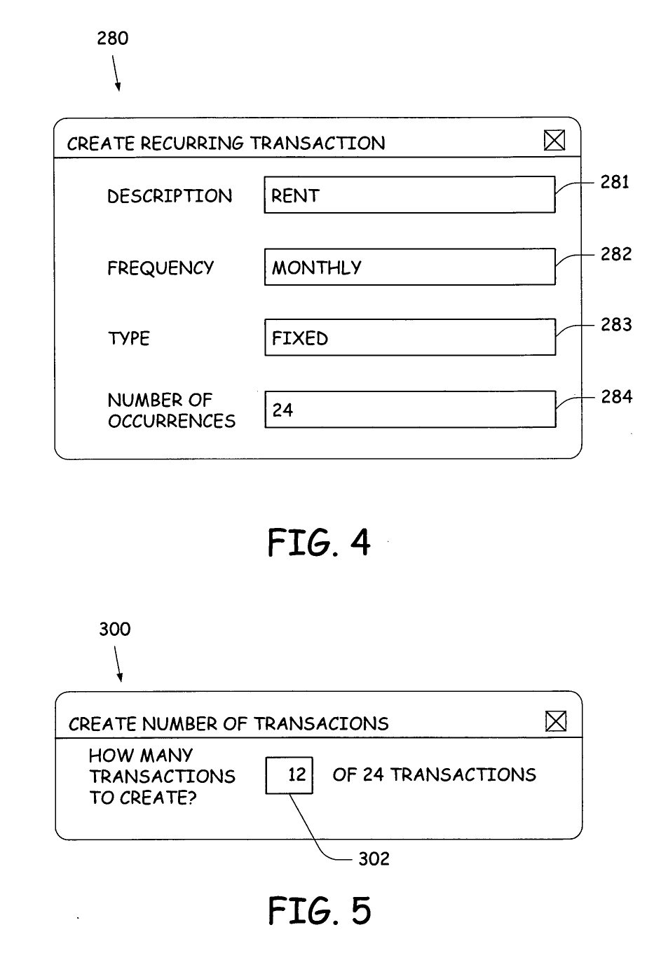

FIG. 4 is an exemplary user interface 280 for defining the settings of a recurring transaction. User interface 280 can be presented to a user upon identifying a transaction as recurring. Fields 281-284 are presented with user interface 280 such that a user can specify parameters related to the recurring transaction. Field 281 is a description of the transaction, shown as “Rent”. Field 282 is a frequency (“Monthly”), field 283 is a type (“fixed”) and field 284 is a number of occurrences (“24”) for the recurring transaction. The type of transaction can be fixed or variable. Fixed recurring transactions include a non-zero value that is included when generating provisional reports. Variable recurring transactions, for example expenses related to electricity, can vary from month-to-month. In such a case, recurring variable transactions that are created include an amount of zero, until the amount is determined and the transaction is updated with the actual amount.

As discussed above, a user may choose to specify a number of transactions that will be created from a specified recurring transaction. FIG. 5 is an exemplary user interface 300 for specifying how many transactions to create from a transaction that has been identified as recurring. User interface 300 also shows the total number of occurrences for the recurring transaction, which is for example 24 as created in FIG. 4. In this case, a user has specified 12 transactions to create.

Using the present invention, recurring transactions can be created. Recurring transactions are valuable in provisional reports for General Ledger accounts since the transactions illustrate future account adjustments. However, the recurring transactions do not alter the current balance on the General Ledger associated accounts until posted. Thus, current reports for the associated accounts are unaffected. As a result of recurring transactions, a convenient approach to accurate provisional reporting can be realized.

Although the present invention has been described with reference to particular embodiments, workers skilled in the art will recognize that changes may be made in form and detail without departing from the spirit and scope of the invention.

What is claimed is:

1. A computer implemented method of recording financial information, comprising:
identifying a transaction as recurring,
wherein the recurring transaction occurs multiple times according to a frequency value; and
creating two or more transactions in the sequence from the recurring transaction according to the frequency value.

2. The method of claim 1 and further comprising:
identifying the two or more transactions in the sequence that were created as unposted.

3. The method of claim 1 and further comprising:
specifying a number of occurrences for the recurring transaction.

4. The method of claim 3 and further comprising:
specifying a number of transactions to create from the number of occurrences for the recurring transaction.

5. The method of claim 1 and further comprising:
specifying the frequency value.

6. The method of claim 1 and further comprising:
creating a future report of a General Ledger account; and
calculating a balance of the account using the two or more transactions that have been created.

7. An application program for a computer readable medium, comprising:
a user interface module adapted to receive information related to a frequency value for a recurring transaction, the recurring transaction occurring multiple times; and
a transaction module adapted to create the recurring transaction and two or more transactions from the recurring transaction according to the frequency value.

8. The application program of claim 7 wherein the transaction module is further adapted to identify the two or more transactions from the recurring transaction as unposted.

9. The application program of claim 7 wherein the user interface module is further adapted to receive information related to a number of occurrences for the recurring transaction.

10. The application program of claim 9 wherein the user interface module is further adapted to receive information related to a number of transactions to create from the number of occurrences for the recurring transaction.

11. The application program of claim 7 and further comprising:
a reporting module adapted to generate a provisional report and calculate a balance using the two or more transaction in the sequence of transactions.
